(19) United States
(12) Patent Application Publication
(10) Pub. No.: US 2003/0110506 A1
(43) Pub. Date: Jun. 12, 2003

(54) Method for adjusting data transmission speed of a voice on demand service system

(75) Inventor: Hyung-Jung Kim, Koyang (KR)

Correspondence Address: JONATHAN Y. KANG, ESQ., LEE & HONG P.C., 11th Floor, 221 N. Figueroa Street, Los Angeles, CA, 90012-2601, US

(73) Assignees: LG Electronics Inc.; LG Telecom, Ltd.

(21) Appl. No.: 10/214,836

(22) Filed: Aug. 8, 2002

(30) Foreign Application Priority Data
Oct. 16, 2001 (KR) 63754/2001

(51) Int. Cl. H04N 7/173

(52) U.S. Cl. 725/95; 725/87; 725/91; 725/100

(57) ABSTRACT

A method for adjusting data transmission speed in a VOD (video on demand) service system, wherein video data from a VOD server is transmitted to a mobile communication terminal in accordance with a VOD service request is provided. In accordance with one aspect of the invention, the method comprises analyzing power control information transmitted between a base station and a mobile communication terminal, wherein the base station provides the means of communication between the mobile communication terminal and a VOD server. The transmission speed of video data transmitted to the mobile communication terminal from the VOD server is then adjusted based on the power control information.

### BACKGROUND OF THE INVENTION

1. Field of the Invention

The present invention relates to a VOD (video on demand) service system, and in particular to a method for varying a data transmission speed of a VOD (video on demand) service system.

2. Description of the Related Art

According to the latest developments of mobile communication technologies, an efficient wireless data communication method for providing a high-quality data communication service is required in accordance with the increase of interest in providing various services through a mobile communication terminal. Particularly, according to the sudden increase of interest in a mobile communication terminal supporting a mass storage data communication such as a moving picture and a multimedia function, technologies for providing various high-quality mass storage data services in real time are required. A VOD service is one of the technologies.

Accordingly, the VOD service is for transmitting video data to home or a mobile terminal in accordance with a user's request through a broadband transmission, by constructing a database of video data, therefore a user can enjoy a request program in real time by using the VOD service.

However, in the VOD service, because the picture quality or the audio quality can be varied in accordance with a transmission speed of video data, the transmission speed of the video data has to be suitably varied in accordance with a reception state of the video data.

FIG. 1 is a block diagram illustrating a construction of a general VOD service. As depicted in FIG. 1, the VOD service system includes a mobile communication terminal 1 transmitting a video service request signal, a VOD server 2 providing a video data service in accordance with the video service request signal from the mobile communication terminal 1, and a base station 3 placed between the VOD server 2 and the mobile communication terminal 1 and providing a transmission path.

The operation of the conventional VOD service system will be described with reference to the accompanying drawings.

A user transmits a video service request signal to the base station 3 by operating the mobile communication terminal 1. The base station 3 transmits the video service request signal received through a wireless network to the VOD server 2 through the wire network, the VOD server 2 transmits a certain video data to the mobile communication terminal 1 through the base station 3 in accordance with the received video service request signal. Accordingly, the VOD service is provided to the user. Herein, the VOD server 2 transmits the video data at a fixed speed.

When a communication channel environment between the base station 3 and the mobile communication terminal 1 changes, the mobile communication terminal 1 measures a packet error rate and a signal to noise ratio (Eb/No) of the video data transmitted from the VOD server 2, inserts information about a reception state of the data into a header of a superior protocol packet as depicted in FIG. 2, and transmits it to the VOD server 2. Herein, the superior protocol packet corresponds to a text of a TCP (transmission control protocol) packet.

Accordingly, the VOD server 2 adjusts the transmission speed of the video data transmitted to the mobile communication terminal 1 by referencing the data reception state information included in the header of a superior protocol packet transmitted from the mobile communication terminal 1. In more detail, when lots of errors occur in the video data transmitted to the mobile communication terminal 1 because a data reception state has deteriorated between the mobile communication terminal 1 and the base station 3, a transmission speed of the video data is lowered. When the data reception state is good, the transmission speed of the video data is increased.

However, in the conventional VOD service system, when the data reception state of the mobile communication terminal is changed frequently, the superior protocol packet has to be frequently transmitted to the VOD server. Accordingly, data transmission of a reverse direction link (i.e., from the mobile communication terminal 1 to the base station 3) is increased and a power consumption of the mobile communication terminal is increased also.

In addition, in the conventional VOD service system, a superior protocol packet is constructed by measuring a packet error rate and a signal to noise ratio (Eb/no), etc. of video data transmitted from the VOD server. Accordingly, because a certain time is required for constructing the superior protocol packet, transmitting data reception state information is delayed. In this case, because the VOD server may receive a previous data reception state information, it can not vary the data transmission speed in real time in accordance with the data reception state.

### SUMMARY OF THE INVENTION

A method for adjusting data transmission speed of a VOD system is provided. In accordance with one or more embodiments, a method for adjusting data transmission speed of a VOD system which is capable of varying a video data transmission speed in real time in accordance with a data reception state comprises: analyzing power control information transmitted between a base station and a mobile communication terminal, wherein the base station provides the means of communication between the mobile communication terminal and a VOD server. The method further comprises changing transmission speed of video data transmitted to the mobile communication terminal from the VOD server, based on the power control information. In certain embodiments, the power control information includes data reception state of the mobile communication terminal and the VOD server periodically receives power control information from the base station.

In another embodiment, a method for varying data transmission speed of a VOD service system comprises transmitting power control information from a mobile communication terminal to a base station; requesting power control information from the base station by a VOD server; and changing transmission speed of video data transmitted from the VOD server to the mobile communication terminal in accordance with the power control information received from the base station. In certain embodiments, the base station updates power control information and the power control information includes data reception state of the mobile communication terminal. Further, in one or more embodiments, the VOD server periodically receives power control information from the base station.

In accordance with yet, another aspect of the invention, a method for adjusting data transmission speed of a VOD service system, comprises: detecting a change in video data reception state in a mobile communication terminal; inserting power control information into a superior protocol packet and transmitting the superior protocol packet to a VOD server when the reception state of the video data changes; and adjusting the transmission speed of video data transmitted by the VOD server to the mobile communication terminal based on the power control information included in the transmitted superior protocol packet. In such embodiment, the mobile communication terminal constructs and transmits a superior protocol packet when the data reception state changes.

In one or more embodiments, a method of adjusting video data transmission speed between a VOD server and a mobile communication terminal comprises: establishing a connection between a VOD server and a mobile communication terminal via a base station; requesting video service from the VOD server; receiving video data at a first speed; calculating power control information based on data reception state of the mobile communication terminal; and transmitting the power control information to the VOD server to allow the VOD server to adjust the data transmission speed.

If data reception state of the mobile terminal has changed then the data transmission speed is changed from a first speed to a second speed. The second speed is less than the first speed, if the data reception state has deteriorated. Otherwise, the second speed is greater than the first speed, if the data reception state has improved. In one or more embodiments, the power control information is transmitted to the VOD server, in response to a request for the power control information from the VOD server. The power control information is calculated by the mobile communication terminal. Alternatively, in another embodiment, power control information is calculated by the base station.

In one or more embodiments, the data reception state is also calculated by the mobile communication terminal. Alternatively, in other embodiments, the data reception state my be calculated by the base station. The data reception state is forwarded to the base station by the mobile communication terminal and the power control information is forwarded to the VOD server by the base station.

In accordance with another embodiment, a method of adjusting video data transmission speed between a VOD server and a mobile communication terminal, the method comprises establishing a connection between a VOD server and a mobile communication terminal; requesting video service from the VOD server; receiving video data at a first speed; calculating power control information based on data reception state of the mobile communication terminal; transmitting the power control information to the VOD server to allow the VOD server to adjust the data transmission speed in accordance with a change in data reception state; and receiving video at a second speed, if it is determined that the data reception state has changed. The power control information is forwarded to the VOD server, in response to a request from the VOD server.

It is to be understood that both the foregoing general description and the following detailed description are exemplary and explanatory and are intended to provide a further explanation of the invention as claimed.

### BRIEF DESCRIPTION OF THE DRAWINGS

With reference to the drawings, the embodiments incorporating the principles, features and concepts of the present invention will be described.

FIG. 1 is a block diagram illustrating a construction of a VOD service system;

FIG. 2 is a conceptual view illustrating a construction of an exemplary conventional VOD data packet;

FIG. 3 is a flow chart illustrating a method for varying a data transmission speed of a VOD service system in accordance with one or more embodiments of the invention; and

FIG. 4 is a flow chart illustrating a method for varying a data transmission speed of a VOD service system in accordance with another embodiment of the present invention.

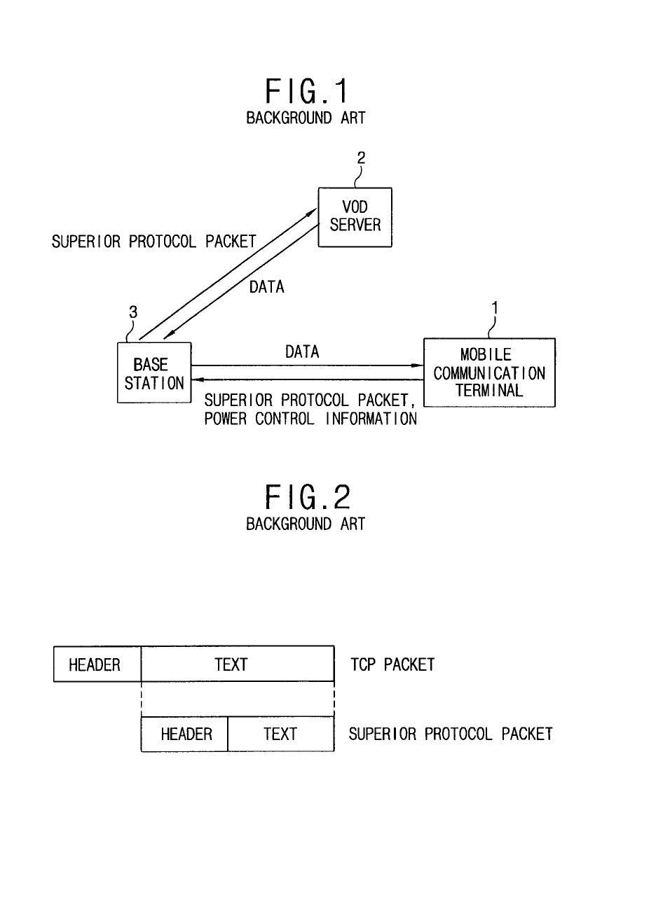

### DETAILED DESCRIPTION OF THE PREFERRED EMBODIMENT

Hereinafter, a method for varying a data transmission speed of a VOD service system in accordance with the present invention will be described in detail with reference to accompanying drawings.

In a CDMA (code division multiple access) system, for example, in order to solve a signal power difference problem in which a signal power received to a base station is differentiated according to a distance between a mobile communication terminal and the base station, provide a same quality service to all users and maximize a reception capacity of a user, power control information having data reception state information is exchanged 800 times per second between the mobile communication terminal and the base station. In more detail, the power control information informing a state and interference of a communication channel, such as a frame error rate and a signal to noise ratio (Eb/No), etc. of video data received to a mobile communication terminal is exchanged between the mobile communication terminal and a base station at a certain time intervals.

Particularly, such as a VOD server, in transmission of mass storage data through the base station, a service quality is determined by a data reception state of the mobile communication terminal. Accordingly, the VOD server has to vary the data transmission speed according to the data reception state of the mobile communication terminal.

A VOD system in accordance with the present invention includes a mobile communication terminal 1, a VOD server 2 providing a video data service and a base station 3 connecting the VOD server 2 to the mobile communication terminal 1.

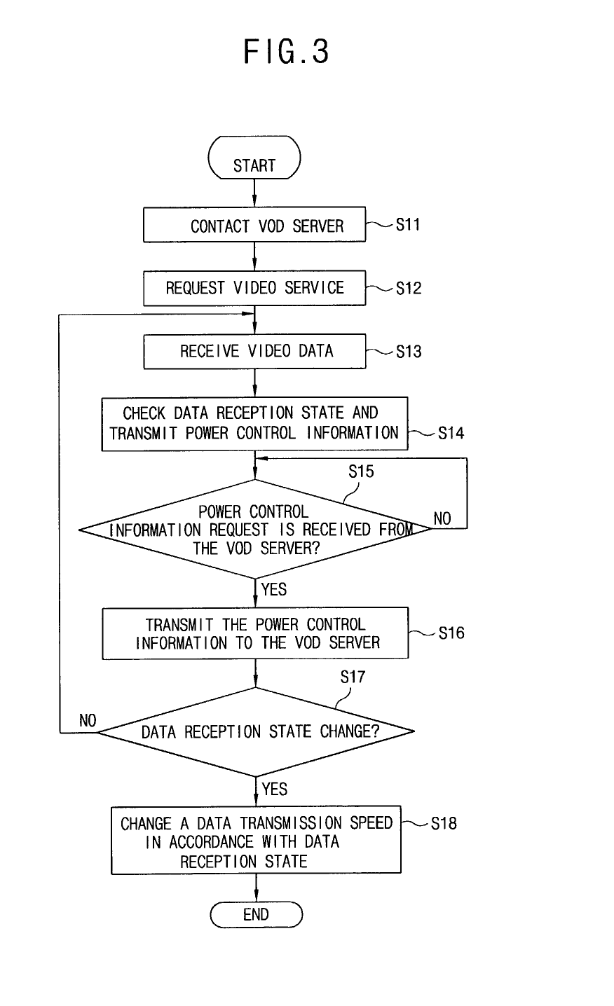

A method for varying a data transmission speed of a VOD service system in accordance with a first embodiment of the present invention will be described in detail with reference to accompanying FIG. 3.

The mobile communication terminal 1 communicates with the VOD server 2 through the base station 3 as shown at step S11 and requests a video service by transmitting a video service request signal to the VOD server 2 in step S12. Such request may be manually made by an operator of the mobile communication terminal 1 or may be automated in association with an application program executed in the terminal 1.

The VOD server 2, after receiving the video service request signal, at a fixed rate transmits video data corresponding to the user's request to the mobile communication terminal 1 through the base station 3, and the video data is displayed on the mobile communication terminal 1, at step S13.

The mobile communication terminal 1 receives the video data transmitted from the VOD server 2, checks the reception state of the video data and transmits power control information to the base station 3, at step S14.

The base station 3 analyzes the data reception state with the received power control information and determines whether a power control information request is received from the VOD server 2, at step S15. If no, the base station 3 continues to exchange the power control information with the mobile communication terminal 1 and does not provide the power control information to the VOD server 2.

Alternatively, when the power control information request from the VOD server 2 is received, the base station 3 collects the latest power control information and transmits it to the VOD server 2, at step S16. The VOD server 2 requests the power control information to the base station 3 at certain time intervals or as needed.

The VOD server 2 determines whether the data reception state is changed on the basis of the transmitted power control information, at step S17, and varies the transmission speed of the video data according to the data reception state, at step S18. In some embodiments, when the data reception state has deteriorated, the VOD server 2 lowers the transmission speed of the video data transmitted to the mobile communication terminal 1. When the data reception state has improved, the VOD server 2 increases the transmission speed, however.

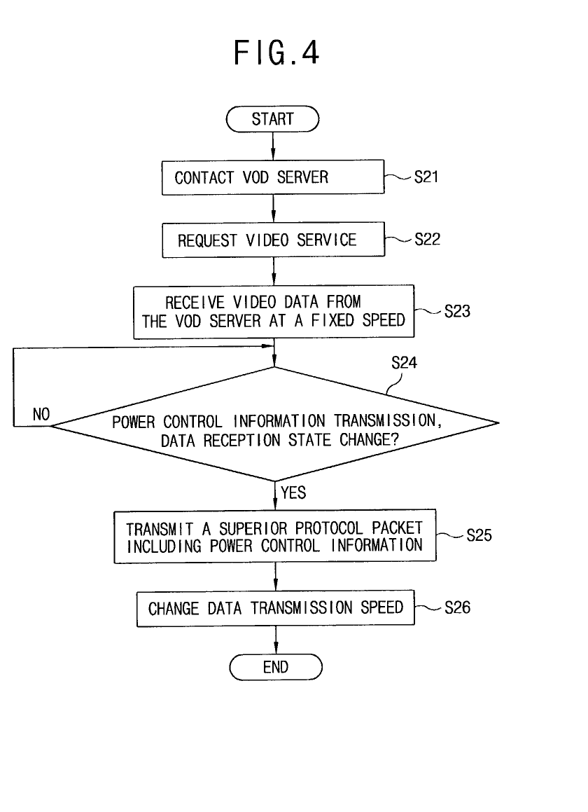

FIG. 4 is a flow chart illustrating a method for varying a data transmission speed of a VOD service system in accordance with another embodiment of the present invention.

The mobile communication terminal 1 requests video service by communicating with the VOD server 2 through the base station 3, and the VOD server 2 transmits video data to the mobile communication terminal 1 as shown at steps S21˜S23.

The mobile communication terminal 1 analyzes the received video data, transmits power control information informing the base station 3 of a data reception state and whether the data reception state is changed as shown at step S24.

The power control information is continuously exchanged between the mobile communication terminal 1 and the base station 3. The mobile communication terminal 1 analyzes the received data and calculates a data reception state.

When the mobile communication terminal 1 determines that the data reception state has changed, it transmits the calculated power control information to the VOD server 2 by including the calculated power control information in a header of a superior protocol packet, at step S25. Thus, the calculated power control information is directly included in the header of the superior protocol, when the mobile communication terminal detects a change in data reception state, or when a request for power control information is forwarded to the mobile terminal 1. The VOD server 2 varies the video data transmission speed on the basis of the superior protocol packet transmitted from the mobile communication terminal 1 at step S26.

In a method for adjusting a data transmission speed of a VOD service system in accordance with the present invention, because a VOD server 2 collects power control information including data reception state information from a base station 3 as needed, a power consumption in transmission of a superior protocol packet from a mobile communication terminal 1 to the VOD server 2 can be reduced, and an overhead about a superior protocol packet construction can be decreased.

In addition, in a method for varying a data transmission speed of a VOD service system in accordance with the present invention, it is possible to obtain a data reception state every time power control information is exchanged between the mobile communication terminal 1 and the base station 3. Thus, a more accurate estimate of a data transmission speed can be achieved.

Particularly, in a method for varying a data transmission speed of a VOD service system in accordance with FIG. 4, a mobile communication terminal 1 transmits power control information to a VOD server 2 by directly including the information in a header of a superior protocol packet. Accordingly the work load of the mobile communication terminal 1 can be decreased.

The present invention described above can be applied to a various digital mobile communications system utilizing various multiple access methods, such as TDMA (Time Division Multiple Access), CDMA (Code Division Multiple Access) and FDMA (Frequency Division Multiple Access). The basic concept of the present invention is, however, independent of the type of the multiple access method used.

The preferred embodiments may be implemented as a method, apparatus or article of manufacture using standard programming and/or engineering techniques to produce software, firmware, hardware, or any combination thereof. Code in the computer readable medium is accessed and executed by a processor. The code in which preferred embodiments are implemented may further be accessible through a transmission media or from a file server over a network. Of course, those skilled in the art will recognize that many modifications may be made to this configuration without departing from the scope of the present invention, and that the article of manufacture may comprise any information bearing medium known in the art.

The flow charts of FIGS. 3 and 4 described specific operations as occurring in a particular order. In alternative implementations, certain of the steps may be performed in a different order, modified or removed and still implement preferred embodiments of the present invention. Moreover, steps may be added to the above described logic and still conform to implementations of the invention.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method for adjusting data transmission speed in a VOD (video on demand) service system, wherein video data from a VOD server is transmitted to a mobile communication terminal in accordance with a VOD service request, the method comprising:
analyzing power control information transmitted between a base station and a mobile communication terminal, wherein the base station provides the means of communication between the mobile communication terminal and a VOD server; and
changing transmission speed of video data transmitted to the mobile communication terminal from the VOD server, based on the power control information.

2. The method of claim 1, wherein the power control information includes data reception state of the mobile communication terminal.

3. The method of claim 1, wherein the VOD server periodically receives power control information from the base station.

4. A method for varying data transmission speed of a VOD service system, comprising:
transmitting power control information from a mobile communication terminal to a base station;
requesting power control information from the base station by a VOD server; and
changing transmission speed of video data transmitted from the VOD server to the mobile communication terminal in accordance with the power control information received from the base station.

5. The method of claim 4, wherein the base station updates power control information.

6. The method of claim 4, wherein the power control information includes data reception state of the mobile communication terminal.

7. The method of claim 4, wherein the VOD server periodically receives power control information from the base station.

8. A method for varying data transmission speed of a VOD service system, comprising:
detecting a change in video data reception state in a mobile communication terminal;
inserting power control information into a superior protocol packet and transmitting the superior protocol packet to a VOD server when the reception state of the video data changes; and
adjusting the transmission speed of video data transmitted by the VOD server to the mobile communication terminal based on the power control information included in the transmitted superior protocol packet.

9. The method of claim 8, wherein the mobile communication terminal constructs and transmits a superior protocol packet when the data reception state changes.

10. A method of adjusting video data transmission speed between a VOD server and a mobile communication terminal, the method comprising:
establishing a connection between a VOD server and a mobile communication terminal via a base station;
requesting video service from the VOD server;
receiving video data at a first speed;
calculating power control information based on data reception state of the mobile communication terminal; and
transmitting the power control information to the VOD server to allow the VOD server to adjust the data transmission speed.

11. The method of claim 10, further comprising:
determining if data reception state of the mobile terminal has changed, based on the power control information; and
changing the data transmission speed from a first speed to a second speed based on the power control information.

12. The method of claim 11 wherein the second speed is less than the first speed, if the data reception state has deteriorated.

13. The method of claim 11 wherein the second speed is greater than the first speed, if the data reception state has improved.

14. The method of claim 10, wherein the power control information is transmitted to the VOD server, in response to a request for the power control information from the VOD server.

15. The method of claim 10, wherein the power control information is calculated by the mobile communication terminal.

16. The method of claim 10, wherein power control information is calculated by the base station.

17. The method of claim 10, wherein the data reception state is calculated by the mobile communication terminal.

18. The method of claim 10, wherein the data reception state is calculated by the base station.

19. The method of claim 10, wherein data reception state is forwarded to the base station by the mobile communication terminal.

20. The method of claim 10, wherein the power control information is forwarded to the VOD server by the base station.

21. The method of claim 10, wherein the reception state is calculated based on packet error rate and signal to noise ration.

22. A method of adjusting video data transmission speed between a VOD server and a mobile communication terminal, the method comprising:
establishing a connection between a VOD server and a mobile communication terminal;
requesting video service from the VOD server;
receiving video data at a first speed;
calculating power control information based on data reception state of the mobile communication terminal;
transmitting the power control information to the VOD server to allow the VOD server to adjust the data transmission speed in accordance with a change in data reception state; and
receiving video at a second speed, if it is determined that the data reception state has changed.

23. The method of claim 21, wherein the power control information is transmitted via a superior protocol packet.

24. The method of claim 21, wherein the connection between the VOD server and the mobile communication terminal is established via a base station.

25. The method of claim 21, wherein the power control information is forwarded to the VOD server, in response to a request from the VOD server.
